(19) United States
(12) Patent Application Publication
(10) Pub. No.: US 2006/0115574 A1
(43) Pub. Date: Jun. 1, 2006

(54) Food product comprising a phytosterol

(76) Inventor: Willem Adriaan De Groot, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/513,441

(22) PCT Filed: Apr. 11, 2003
(86) PCT No.: PCT/EP03/03789

§ 371 Date: Dec. 27, 2005

(30) Foreign Application Priority Data
May 3, 2002 (EP) 02076794.3

(51) Int. Cl. A23D 9/00

(52) U.S. Cl. 426/601

(57) ABSTRACT

Shallow frying products comprising from 35 to 90 wt % fat, phytosterols and a specific amount of salt and lecithin, and an aqueous phase with a pH of from 4.5 to 6.5 are less prone to oxidation of phytosterols and unsaturated fatty acids under frying conditions.

### FIELD OF THE INVENTION

The invention relates to a food product comprising from 35 to 90 wt % fat and a phytosterol.

### BACKGROUND OF THE INVENTION

Since several years consumers are interested in reduction of their blood cholesterol level because high blood cholesterol level is believed to contribute to heart disease.

Sterols occur widely in plants and animals and are important compounds in the human diet. Cholesterol, which is the dominant sterol in animal food products, has often been associated with the incidence of coronary heart diseases. In vegetable oils, more varying and complex mixtures of sterols occur. The sterols from vegetable origin are generally called plant sterols or phytosterols. Phytosterols have demonstrated a blood cholesterol lowering effect and have therefore been proposed as therapeutic agents for hypercholesterolemia. It has been shown frequently now that when plant sterols are added to food products at a level of 8% they will lower LDL-cholesterol on average by 10% (Weststrate J. A. and Meijer G. W. Eur. J. Clin. Nutr. 52 (1998) 334-343. “Plant sterol-enriched margarines and reduction of plasma total- and LDL-cholesterol concentrations in normocholesterolemic and mildly hypercholesterolemic subjects.”)

Furthermore for example EP-A-594612, and EP-A-829434 disclose food products comprising as the active component a phytosterol. Consumption of these products on a regular basis in the prescribed amounts is claimed to lead to a reduction in blood cholesterol.

Besides reduction of cholesterol level in blood, individual consumers are also interested in health aspects of oil containing food products. It is generally known that polyunsaturated fatty acids forming the building blocks of some triglyceride oils, also contribute to cholesterol lowering. Therefore products comprising both phytosterols and a considerable amount of polyunsaturated fatty acids have been developed. Examples of such products are Becel pro activ™ spreads. Such products are for example described in EP-A-828434.

It is known that both polyunsaturated fatty acids and phytosterols are prone to oxidation under certain conditions. For example a high temperature treatment of such products when used in shallow frying or deep frying (see EP-A-771531) can potentially lead to oxidation of both polyunsaturated fatty acids and phytosterols. The resulting products in some cases suffer from off taste.

Cholesterol and the main phytosterols (sitosterol, stigmasterol, and campesterol) all belong to the same class of sterols, the 4-desmethyl sterols. Based on the ample amount of information published concerning the oxidation of cholesterol, it has been known for several decades that sterols can be oxidised to so-called oxysterols or sterol oxides. This is attributed to the presence of an unsaturated B-ring in the 4-desmethylsterols. The oxidation is believed to proceed according to a classical auto-oxidation mechanism, analogous to the oxidation of unsaturated fatty acids. The oxidation of sterols, however, proceeds much slower than the oxidation of mono-unsaturated fatty acids, due to steric hindrance in the sterol moiety.

It is an object of the current invention to provide a product suitable for shallow frying comprising both (poly) unsaturated fatty acids in the form of triglyceride, and phytosterols wherein the composition is such that both the slow oxidation of sterols and the regular oxidation of fatty acids is limited.

### SUMMARY OF THE INVENTION

It has surprisingly been found that fat based food products comprising a specific amount of salt and lecithin and an aqueous phase with a moderately acidic pH, show reduced oxidation of both sterols and unsaturated fatty acids upon shallow frying.

Therefore, in a first aspect, the invention relates to a food product suitable for shallow frying comprising from 35 to 90 wt % fat, from 3 to 15 wt % of a phytosterol, an aqueous phase, salt and lecithin wherein the amount of lecithin is from 0.1 to 0.8 wt %, the amount of salt is from 0.2 to 5 wt %, and wherein the pH of the aqueous phase is from 4.5 to 6.5 and wherein the product optionally comprises a thickener in an amount of at most 1 wt %.

In a further aspect the invention relates to the use of such food products in shallow frying.

### DETAILED DESCRIPTION OF THE INVENTION

Where percentages are used in the specification and claims, these are weight percentages unless otherwise is indicated. The weight percentages are calculated on total product weight unless otherwise is indicated.

The products according to the invention are suitable for shallow frying. Well-known shallow frying media are butter and margarine (pourable or solid in tub or wrapper). The food products according to the invention may be used as alternatives to such traditional shallow frying media. The products comprise an aqueous phase and a fat phase. The products comprise from 35 to 90 wt % fat. At lower fat percentage it was found that the products do not show the desired frying characteristics; especially resulting in low oil amount in the frying pan and an increased tendency to spattering for some formulations.

Spattering of a water and oil-containing product, especially where the continuous phase is the fat phase is believed to be caused by superheating of water droplets. At a certain point after heating water droplets explosively evaporate, whereby the product can be spread all over the surroundings of a frying pan in which the emulsion is heated. This may cause danger to the person who fries foodstuff in the heated emulsion and it may cause a mess in the kitchen.

Phytosterol in the context of the invention is defined according to the definition used by Kochhar in Prog Lip Res Vol 22, (1983) pp 161-164, and includes their saturated equivalents. Esterified derivatives such as phytosterols or stanols esterified to fatty acids are also encompassed in the invention. Methods for esterification of phytosterols are for example disclosed in WO-A-98/38206 and EP-A-594612. The preferred phytosterols are selected from the group comprising beta sitosterol, beta sitostanol, stigmasterol, stigmastanol, campesterol and campestanol or their mixtures and their esters of fatty acids.

Most preferably the phytosterol is a fatty acid ester of beta sitosterol or beta sitostanol or a derivative thereof.

The fatty acids suitable for esterification are preferably selected from fatty acids derived from soy bean oil, rapeseed oil, palm oil, sunflower oil, corn oil, safflower oil, cotton seed oil, palmkernel oil, coconut oil, linseed oil, butter or fractions thereof, or lauric oils or a combination thereof. Most preferred the fatty acid is derived from sunflower oil or rapeseed oil.

The amount of phytosterol is from 3 to 15 wt % on basis of the weight of the underivatised phytosterol. Preferably the amount is from 5 to 10 wt %, more preferred from 7 to 9 wt % on total product weight. In a preferred embodiment the phytosterol is a phytosterolester added in an amount of from 8 to 16 wt % on total product weight.

Compositions according to the invention show reduced levels of oxidized products during and after shallow frying. Preferably the level of steroloxide is less than 500 mg/kg original product. Even more preferred the level is below 400 mg/kg, most preferred below 300 mg/kg.

It was found that increased salt levels lead to reduced oxidation during shallow frying of both the phytosterols and the fatty acids derived from triglycerides present in the food product according to the invention. Therefore the amount of salt is from 0.2 to 5 wt %, preferably from 0.5 to 5 wt %. More preferably the amount of salt is from 1 to 5 wt %, even more preferably from 2 to 3 wt %. The salt can be any food grade salt. Suitable salts are for example selected from the group comprising sodium chloride, potassium chloride, calcium chloride and combinations thereof.

Preferred salts are those that do act physically as a salt but do not (or to a lesser extent than NaCl) impart a salty impression to the product. Examples of such salts are potassium chloride and potassium citrate.

For most applications, especially in countries where consumers like salty frying products, NaCl is the preferred salt.

The presence and amount of lecithin in the food products according to the invention is of critical importance to the level of oxidation. It was found that if the level of lecithin is from 0.1 to 0.8 wt %, the products show reduced oxidation of both the phytosterol and the fatty acid moiety. Low levels, below 0.1 wt % and also high levels, above 0.8 wt %, were found to lead to increased levels of oxidation, especially of the phytosterol moiety. It is preferred to use lecithin at a level of from 0.1 to 0.7 wt %, more preferred from 0.2 to 0.5 wt %.

For the purpose of the invention, lecithins, which comprise phosphoacylglycerols, can be divided in three groups according to their preparation. The first group is formed by native lecithins such as Bolec ZT™. Native lecithins are for example obtained from triglyceride oils, which have been filtered, extracted and stripped.

The native lecithins can be separated from the oils by use of their affinity for water, this rendering them oil insoluble. According to another, more preferred definition, native lecithins are those which have a phosphatidylcholine to phosphatidylethanolamine ratio of at most 1.3, in combination with the total amount of lysophosphatides being at most 5 wt % of all phosphatides making up the native lecithin composition. The second group of lecithins is formed by (partly) hydrolysed lecithins, which originate from native lecithins, which have been hydrolysed for example by use of the enzyme phospholipase A or by chemical hydrolysis. Hydrolysed lecithins can also be prepared by chemical synthesis.

A third group of lecithins comprises fractionated lecithins such as the alcohol soluble fraction of native lecithins such as cetinol™.

This type of lecithin can be obtained in a process wherein native lecithins are extracted with alcohol.

Examples of these three groups of lecithins are: native lecithine: Bolec ZT™, Adlec™, Sterpur PM™; hydrolyzed lecithine BOLEC MT™, Sterpur E™, Adlec E™; fractionated lecithin: Cetinol™, Nathin 3-KE™.

For the purpose of the invention lecithins are from vegetable origin.

Lecithins in each group can optionally be de-oiled lecithins.

In a preferred embodiment of the invention, the lecithin is an alcohol soluble fraction of a lecithin.

The aqueous phase of the products is characterised by a pH of from 4.5 to 6.5, preferably from 4.7 to 6.5. More preferably the aqueous phase has a pH of from 4.8 to 6.2, preferably from 5 to 6. Such pH is for example obtained by the addition of an acid. Suitable acids include lactic acid, citric acid, hydrochloric acid. The preferred acid is citric acid.

The products comprise from 35 to 90 wt % fat. Preferred products are those which comprise from 40 to 90 wt % fat, more preferred from 60 to 90 wt % fat, most preferred from 60 to 80 wt % fat. Especially preferred the products are fat continuous. Such products were found to be most suitable for shallow frying.

In an even more preferred embodiment the invention relates to a fat continuous food product suitable for shallow frying, comprising from 60 to 90 wt % fat, from 10 to 15 wt % of a phytosterol fatty acid ester, an aqueous phase, salt and lecithin wherein the amount of lecithin is from 0.2 to 0.5 wt %, the amount of salt is from 0.5 to 3 wt %, and wherein the pH of the aqueous phase is from 4.8 to 6.5.

Optionally the food product comprises a thickener. Thickeners such as alginate, starch, gelatinised starch, gums including gellan gum, locust bean gum, xanthan gum or combinations thereof are commonly used to provide texture and/or viscosity in low fat food products. It was however found that such compositions tended to increase the level of oxidation of phytosterols in shallow frying products and therefore they are preferably essentially absent in the food products according to the invention. Small amounts of at most 1 wt % are in most formulations tolerable though less preferred. In the context of the invention essentially absent is defined as less than 0.1, preferably less than 0.01 wt %.

Generally shallow frying products comprise an emulsifier to assist in the homogeneous admixture of aqueous phase and fat phase. Suitable emulsifiers are preferably selected from the group comprising saturated or unsaturated monoglycerides, saturated or unsaturated diglycerides, polyoxysorbitanesters, citric acid esters, lactic acid esters or a combination thereof. Preferably the food product comprises a monoglyceride, more preferred a saturated monoglyceride.

For improvement of taste and to impart nutritional value, the products optionally comprise a protein. Said protein can be of vegetable or dairy origin whereby dairy origin is preferred.

Dairy proteins are suitably selected from sources such as milk protein, whey protein, skim milk powder, whey powder, sweet whey (powder), buttermilk or butter milk powder or a combination thereof. The amount of such protein is for example from 0.2 to 3, preferably from 0.5 to 2 wt %.

In an alternative embodiment the products comprise one or more well known antioxidants. These were found especially suitable for reduction of oxidation of fatty acids. Examples of well known antioxidants are propylgallate, tocopherol, ascorbic acid (ester).

Such compositions are especially suitable for use at increased pH over 5.3.

In order to further improve the oxidative stability of the products, especially of the unsaturated fatty acids contained therein, a sequestrant such as EDTA or citric acid is optionally added.

The food products are suitable for shallow frying. The products may be pourable or spreadable. Spreadable products are preferred. In addition to the above described ingredients the products may comprise optional ingredients that are commonly used in shallow frying agents. Such ingredients include but are not limited to colouring agents, flavour components, preservatives such as potassium sorbate, herb, fruit or nut particles, and healthy ingredients such as vitamins, fibres.

The fat phase of the food products is formed by any suitable fat or fat blend. It will be appreciated that pourable products require a different fat composition than spreadable products. Guidance on composition of the fat blend is provided below.

The known pourable frying products fat blend usually consists of a mixture of an oil, a fat which at ambient temperature is fully liquid, and a fat which is solid at ambient temperature, the so-called hardstock. The ratio of liquid and solid fat is chosen such that after proper processing together with an aqueous phase a product with a suitable squeezable or pourable consistency is obtained. The presence of hardstock fat in liquid frying products aims to contribute to stabilisation of the emulsion.

The solid fat crystals, which are needed for the stability of the emulsion, on the other hand may adversely affect its pourability. Liquid frying products manufacture therefore requires a hardstock fat with properties that are delicately balanced. Any suitable hardstock may be used.

Fully hydrogenated high erucic rapeseed oil (shortly denoted as fully hardened rapeseed oil or RPh70) is a well known hardstock fat which complies with the above specification. It is suited for the manufacture of satisfactory liquid or squeezable frying products, which combine good stability with good pourability. However also other hardstocks may be used such as (partially) hydrogenated sunflower seed oil with a melting point of about 69° C., soy bean oil with a melting point of about 65° C., palm oil with a melting point of about 58° C., arachidic oil with a melting point of about 60° C. and cotton seed oil with a melting point of about 62° C. Combinations of one or more of these hardstock fats or interesterified blends of these fats may also be suitably applied. Presently, from all above-mentioned fats mainly fully hardened rapeseed oil is employed for the commercial preparation of high quality liquid frying products. Its use is described e.g. in U.S. Pat. No. 5,756,142. Most liquid or squeezable frying products are prepared with 1.5-5 wt.% hardstock fat on total product.

In addition to the hardstock the fat blend comprises a relatively low melting fat.

As the low melting fat an oil rich in triglycerides comprising (poly) unsaturated fatty acid residues is highly preferred. Therefore the low melting fat is preferably selected from the group comprising sunflower oil, soybean oil, rapeseed oil, cottonseed oil, olive oil, corn oil, groundnut oil, or low melting butterfat fractions and/or combinations thereof. These fats may be partially hydrogenated.

The fat blend for a spreadable product preferably comprises a hardstock fat and a liquid oil. The hardstock is preferably a saturated fat or a fat of which at least about 75% of the fatty acids are saturated fatty acids. Optionally the hardstock fat is an interesterified fat. The liquid oil is preferably an oil high in polyunsaturated fatty acids such as rapeseed oil, sunflower oil, olive oil, sesame oil, safflower oil, linseed oil, soy bean oil, linola oil or a combination thereof.

The food products may be prepared by any suitable process. To prepare a pourable product, for example a premix comprising all ingredients is prepared, followed by blending and mixing in order to establish a suitable emulsion. If desired the crystallisation of solid fat if present may either be performed a priory or as a processing step in which the premix is cooled by one or more scraped surface heat exchangers. In such a step also the process of emulsification by homogenisation could take place. Emulsification could on the other hand as well be envisaged by other kinds of techniques as, e.g. membrane emulsification and alike.

If a small amount of hardened fat such as hardened rapeseed oil is present in the final product, a preferred process comprises the steps of melting triglyceride oil in shear mixer such as an A unit™, cooling to below the alpha crystallisation temperature and subsequently, or prior to cooling, mixing the triglyceride oil with the aqueous phase.

The resulting product is preferably stored at a temperature from 0 to 15° C.

For the preparation of a spreadable product, it is preferred that a premix is prepared at a temperature of about 40 to 70° C. such that the fats are melted. The composition is then processed through a high shear unit with simultaneous cooling, which is optionally repeated, followed by processing in a pin stirrer and storage of the final product at a temperature from 0 to 15° C.

In a further embodiment the invention relates to use of the product according to the invention in shallow frying of foodstuff. Preferably the product is used in an amount of about 5 to 50 g and heated to about 150° C. before foodstuff to be fried is put in.

The invention is now illustrated by the following non-binding examples.

### EXAMPLES

General

Determination of Spattering Value

The spattering behaviour of food products according to the invention was evaluated after storage of the products 8 days at 5° C. and finally 16 h of tempering at 15° C.

Primary spattering (SV1) was assessed under standardised conditions in which an aliquot (31.6 g) of the food product was heated in a glass dish and the amount of fat spattered onto a sheet of paper held above the dish was assessed after the water content of the food product had been driven off by heating.

In assessment of the spattering value about 31.6 g food product was heated in a glass dish on an electric plate set at about 205° C. The fat that spattered out of the pan by force of expanding evaporating water droplets was caught on a sheet of paper situated above the pan. The image obtained after 20 minutes was compared with a set of standard pictures number 0-10 whereby the number of the best resembling picture was recorded as the spattering value. 10 indicates no spattering and zero indicates very bad spattering. The general indication is as follows.

| Score | Comments |
|---|---|
| 10 | Excellent |
| 8 | Good |
| 6 | Passable |
| 4 | Unsatisfactory for SV1, |
| | almost passable for SV2 |
| 2 | Very poor |

Typical result for household margarines (80 wt % fat) is 8 for primary spattering (SV1).

Analysis of Sterol Oxide Level

The method used is based on the method described by Dutta and Appelqvist, 1997 (Dutta P. C. and Appelqvist L.-A. JAOCS 74 (1997) 647-657. “Studies on phytosterol oxidation products. I: Effect of storage on the content in potato chips prepared in different vegetable oils.”).

After heating the product for 15 minutes at approx. 180° C. in a frying pan, fat extracts were prepared if necessary, a cold saponification procedure was applied and the unsaponifiables were extracted. Subsequently the sterol oxides were separated from the bulk of sterols and other unsaponifiables by HPLC and the sterol oxide fraction was subjected to GC, where they were identified by MS and quantified by FID.

Processing

A premix of all ingredients was prepared at a temperature of 60° C. The composition was then processed through a high shear unit with simultaneous cooling, which was repeated, followed by processing in a pin stirrer and storage of the final product at 5° C.

The products contain about 60 wt % fat and 8% phytosterols expressed as wt % free phytosterols. The sterols are present in the form of fatty acid esters of mainly beta-sitosterol, campesterol and stigmasterol with fatty acids derived from sunflower oil.

Detailed product composition is shown in table 1

TABLE 1
Ingredient

| | | | | | Compar- |
|---|---|---|---|---|---|
| | Example | | | | ative |
| Ingredients | 1, wt % | 2 | 3 | 4 | example |
| Fat phase | | | | | |
| Fat blend | 54 | 54 | 54 | 54 | 54 |
| Sterolester | 13.3 | 13.3 | 13.3 | 13.3 | 13.3 |
| Lecithin (cetinol) | 0.27 | 0.12 | 0.27 | 0.5 | 0.05 |
| Propylgallate | 0.0 | 0.0 | 0.0 | 0.005 | 0.005 |
| Aqueous phase | | | | | |
| Salt (NaCl) | 3.0 | 1.28 | 0.55 | 2.0 | 0.2 |
| Thickener | 0.0 | 0.0 | 0.0 | 0.0 | 1.86 |
| (Paselli starch) | | | | | |
| Sequestrant | 0.0 | 0.0 | 0.0 | 0.025 | 0.005 |
| (EDTA) | | | | | |
| Citric acids | 0.039 | 0.020 | 0.039 | 0.0 | 0.0 |
| pH | 4.7 | 5.3 | 5.9 | 5.5 | 3.5 |

The fat used was a combination of a hardstock fat which was an interesterified blend of palm oil and palm kernel oil fractions and a liquid oil which was sunflower oil.

The total is made to 100 wt % by addition of water.

Results are presented in table 2

| | Steroloxide formed | Oxidation of fat |
|---|---|---|
| Example | (mg per kg spread) | Determined by tasting |
| 1 | 66 | Good Taste |
| 2 | 83 | Good Taste |
| 3 | 116 | Good Taste |
| 4 | 180 | Good Taste |
| Comparative | 1565 | Rejected because of |
| example | | off taste |

1. Food product suitable for shallow frying comprising from 35 to 90 wt % fat, from 3 to 15 wt % of a phytosterol, an aqueous phase, salt and lecithin characterised in that the amount of lecithin is from 0.1 to 0.8 wt %, the amount of salt is from 0.2 to 5 wt %, in that the pH of the aqueous phase is from 4.5 to 6.5 and in that the product optionally comprises a thickener in an amount of at most 1 wt %.

2. Food product according to claim 1 wherein the amount of fat is from 60 to 90 wt %.

3. Food product according to claim 1 which is fat continuous.

4. Food product according to claim 1 having a pH of from 4.8 to 6.2, preferably from 5 to 6.

5. Food product according to claim 1 wherein the amount of lecithin is from 0.1 to 0.7 wt %, preferably from 0.2 to 0.5 wt %.

6. Food product according to claim 1 wherein the amount of salt is from 1 to 5 wt %, preferably from 2 to 3 wt %.

7. Food product according to claim 1 which further comprises an acid, preferably citric acid.

8. Food product according to claim 1 comprising a protein, preferably selected from the group comprising milk protein, whey protein, skim milk powder, whey powder, sweet whey (powder), buttermilk or butter milk powder or a combination thereof.

9. Food product according to claim 1 further comprising an antioxidant, preferably selected from the group comprising propylgallate, tocopherol, ascorbic acid (ester) or a combination thereof.

10. Food product according to claim 1 wherein the amount of thickener is below 0.1 wt %, preferably the thickener is essentially absent.

11. Use of a food product according to claim 1 for shallow frying.
